(19) United States
(12) Patent Application Publication
(10) Pub. No.: US 2005/0241545 A1
(43) Pub. Date: Nov. 3, 2005

(54) Methods of extending the shelf life of and revitalizing lightweight beads for use in cement compositions

(76) Inventors: Richard F. Vargo JR., Katy, TX (US); David S. Kulakofsky, Katy, TX (US)

Correspondence Address: CRAIG W. RODDY;HALLIBURTON ENERGY SERVICES, P.O. BOX 1431, DUNCAN, OK, 73536-0440, US

(21) Appl. No.: 10/922,620

(22) Filed: Aug. 20, 2004

Related U.S. Application Data
(63) Continuation-in-part of application No. 10/833,616, filed on Apr. 28, 2004.

(51) Int. Cl. C04B 16/08

(52) U.S. Cl. 106/823

(57) ABSTRACT

In an embodiment, the shelf life of lightweight beads to be used in a cement composition may be extended by combining the lightweight beads with a fluid such as water to inhibit the lightweight beads from forming an agglomeration while they are being stored or transported. In another embodiment, lightweight beads that have already formed an agglomeration may be revitalized for use in a cement composition by adding a fluid such as water to the lightweight beads to reduce a size of the agglomeration. The agglomeration may originally have a width greater than or equal to about 1 inch. Adding the fluid to the lightweight beads may cause at least a portion of the beads to separate from the agglomeration into individual beads having a width of less than or equal to about 200 microns.

### CROSS-REFERENCE TO RELATED APPLICATIONS

This application is a continuation-in-part of U.S. patent application Ser. No. 10/833,616, filed Apr. 28, 2004 and entitled “Methods of Making Cement Compositions Using Liquid Additives Containing Lightweight Beads,” which is hereby incorporated by reference herein in its entirety.

### FIELD OF THE INVENTION

The present invention generally relates to cement compositions, and more particularly to methods of revitalizing an agglomeration of lightweight beads and methods of extending the shelf life of lightweight beads by combining the beads with a fluid to form a liquid additive for a cement composition.

### BACKGROUND OF THE INVENTION

Well cementing is a process used in penetrating subterranean formations to recover subterranean resources such as gas, oil, minerals, and water. In well cementing, a well bore is drilled while a drilling fluid is circulated through the well bore. After the drilling is terminated, a string of pipe, e.g., casing, is run in the well bore. Primary cementing is then typically performed whereby a cement slurry is pumped down through the string of pipe and into the annulus between the string of pipe and the walls of the wellbore to allow the cement slurry to set into a hard mass and thereby seal the annulus. Subsequent secondary cementing operations may also be performed. One example of a secondary cementing operation is squeeze cementing whereby a cement slurry is forced under pressure to areas of lost integrity in the annulus to seal off those areas.

Low density or lightweight cement compositions are commonly used in wells that extend through weak subterranean formations to reduce the hydrostatic pressure exerted by the cement column on the weak formation, which otherwise might undesirably fracture and cause loss of drilling fluids and or cementatous fluids and damage the formations which may be targeted for production. Conventional lightweight cement compositions are made by adding more water to reduce the slurry density. Unfortunately, the addition of more water typically increases the cure time and reduces the strength of the resulting cement column. Lightweight cement compositions containing lightweight beads have been developed as a better alternative to cement compositions containing large quantities of water. The lightweight beads reduce the density of the cement composition such that less water is required to form the cement composition.

The lightweight beads are typically combined with a dry bulk mixture of cement by blowing the beads back and forth through the cement to evenly distribute them in the cement. The resulting dry blend may then be transported in a bulk container such as a tank to an on-site location near where its use is intended. The dry blend can then be mixed with water to form a slurry for use in a wellbore. Forming a dry blend of the cement and the lightweight beads in this manner can be problematic. First, while in storage the beads may agglomerate together into masses that are greater than or equal to about 1/4 inch in width. Some agglomerations may be as large as 2 or 3 feet in width. In agglomerated form, the beads cannot be evenly distributed throughout the dry blend. Therefore, the beads that are agglomerated together are often disposed of before using them in the dry blend. This loss of the beads unfortunately increases the overall cost of the final cement slurry. Further, the beads that do become distributed throughout the dry blend can segregate during loading, unloading, and transporting.

Another problem associated with pre-mixing the cement with the lightweight beads is that once the cement and the beads have been blended and transported to an on-site location, little flexibility exists to allow for a change in the original design specification of the slurry. That is, the relative concentrations of the cement and the beads typically cannot be changed during the period between when they are blended and when they are used in the wellbore. Such a change may be needed due to changing conditions in the wellbore.

A need therefore exists to prevent the lightweight beads being used in a cement slurry from agglomerating together or to develop a way to revitalize beads that have already agglomerated together. Further, it is desirable to be capable of altering the concentrations of the components in the cement slurry whenever needed to account for changing conditions in the wellbore into which it is to be pumped.

### SUMMARY OF THE INVENTION

In an embodiment, methods of extending a shelf life of lightweight beads to be used in a cement composition include combining the lightweight beads with a fluid such as water to inhibit the lightweight beads from forming an agglomeration while they are being stored or transported. The mixture comprising the lightweight beads and the fluid forms a liquid additive for the cement composition. A mass ratio of the fluid to the lightweight beads may be less than or equal to about 1:1. The lightweight beads and the fluid may be placed in a vessel in which the fluid is circulated from the bottom of the vessel to the top of the vessel, agitated with a paddle, or both.

In another embodiment, methods of revitalizing an agglomeration of lightweight beads for use in a cement composition include adding a fluid such as water to the lightweight beads, thereby separating all or a portion of the beads from the agglomeration. The agglomeration may originally have a width greater than or equal to about 1 inch. Adding the fluid to the lightweight beads may cause at least a portion of the beads to separate from the agglomeration into individual beads having a width of less than or equal to about 200 microns. A mass ratio of the fluid to the lightweight beads may be less than or equal to about 1:1. The mixture comprising the lightweight beads and the fluid forms a liquid additive that may be transported in a vessel to a location near a wellbore and combined with a cement to form a cement composition. The fluid in the liquid additive may be circulated from the bottom of the vessel to the top of the vessel during this time. The concentrations of the lightweight beads and the cement in the cement composition may be changed as needed prior to pumping the cement composition into the wellbore.

### BRIEF DESCRIPTION OF THE DRAWINGS

FIG. 1 depicts a side plan view of a system for transporting a liquid additive to an on-site location where it may be combined with a cement to form a cement slurry.

### DETAILED DESCRIPTION OF THE PREFERRED EMBODIMENTS

According to an embodiment, the shelf life of lightweight beads for use in a cement composition may be extended by combining the beads with an effective amount of a fluid to inhibit the beads from forming an agglomeration while they are being stored or transported. As used herein, “lightweight bead” is defined as a particle that can be combined with a cement composition to lower its density, wherein the particle may be solid or hollow and is preferably a spherical, hollow object filled with gas. Further, the “shelf life” of the lightweight beads refers to the period of time during which the beads may be stored without forming an agglomeration, wherein an “agglomeration” refers to beads that are grouped together into a mass having a width of greater than or equal to about 1/4 inch. The shelf life of the beads may be extended to greater than or equal to about 6 months, alternatively greater than or equal to about 1 year, by combining them with the fluid. The resulting mixture of the lightweight beads and the fluid forms a liquid additive for a cement composition. The liquid additive may be prepared as described herein, optionally stored and/or transported during the shelf life of the beads, and then combined with cement when it is desirable to form a cement composition.

In another embodiment, lightweight beads that have already undesirably formed an agglomeration may be revitalized for use in a cement composition by adding an effective amount of fluid to the beads to reduce a size of the agglomeration. Such an agglomeration may form while the beads are being stored or while the beads are being transported to an on-site location for use in a cement composition. The addition of the fluid to the agglomeration may cause at least a portion of the beads to separate from the agglomeration into individual beads. In embodiments, greater than or equal to about 50%, greater than or equal to about 80%, or greater than or equal to about 90% of the beads in the agglomeration separate from the agglomeration. Each individual bead may have a width of less than or equal to about 200 microns, alternatively less than or equal to about 150 microns. The cluster of beads that remain grouped together after this separation of a portion of the beads is typically less than about 1/4 inch in width. The mixture of the revitalized beads and the fluid forms a liquid additive for a cement composition that can be prepared as described herein, optionally stored and/or transported to a work location, and mixed with cement. Due to their revitalization, the beads typically become suspended in the cement, thus forming a cement composition of relatively low density.

Examples of lightweight beads that may be employed in the previous embodiments include but are not limited to cenospheres, glass spheres, ceramic spheres, and combinations thereof. In an embodiment, the lightweight beads are borosilicate glass beads such as the SCOTCHLITE HGS series of beads sold by the 3M Company. For example, the lightweight beads may comprise HGS 4,000 beads, HGS 10,000 beads, HGS 18,000, or combinations thereof. The lightweight beads usually have a specific gravity less than that of the fluid and thus float in the fluid. However, some types of lightweight beads such as solid beads may have a specific gravity about equal to that of the fluid.

Examples of fluids with which the lightweight beads may be combined include but are not limited to fresh water and/or salt water such as an unsaturated aqueous salt solution or a saturated aqueous salt solution, e.g., brine or seawater. The liquid additives may further include additional materials as deemed appropriate by one skilled in the art. Examples of such materials include but are not limited to typical cement additives such as dispersants, cement friction reducers, fluid loss control additives, set retarding agents, set accelerating agents, strength retrogression control agents, viscosifying agents, and formation conditioning agents.

In the disclosed embodiments, the lightweight beads and the fluid may be blended until the beads are distributed throughout the fluid. By way of example, the lightweight beads and the fluid may be blended using a blender, a mixer, a stirrer, a jet mixing system, or a similar device known in the art. In an embodiment, a recirculation system keeps the beads uniformly distributed throughout the fluid. In an embodiment, the fluid comprises water, and at least one dispersant is blended with the lightweight beads and the water to reduce the volume of water required to suspend the beads. An example of a suitable dispersant is CFR-3 dispersant, which is commercially available from Halliburton, Inc. The concentration of the dispersant in the ensuing cement composition may be determined based on the desired slurry properties in accordance with conventional design techniques. In an embodiment, the amount of the dispersant added may be selected such that its concentration in the ensuing cement composition is in a range of from about 0.03 gallon/sack of cement (gal/sk) to about 0.30 gal/sk. In an alternative embodiment, the dispersant may already be present in the fluid comprising water before the fluid is blended with the lightweight beads. In another embodiment, the fluid comprises water, and at least one cement friction reducer is blended with the lightweight beads and the water. In an alternative embodiment, the friction reducer may already be present in the fluid comprising water before the fluid is blended with the lightweight beads.

In an embodiment, the amount of water combined with the lightweight beads is minimized to decrease the load capacity required to transport the liquid additive (or alternatively to increase the amount of lightweight beads that can be transported by a given load capacity) and thereby lower the cost of transporting the liquid additive. As such, the liquid additive is preferably “substantially absent” of water absorbing materials, meaning that it does not contain water absorbing materials that could undesirably increase the amount of water required to suspend the lightweight beads. Examples of such undesirable water absorbing materials include but are not limited to water swellable clays such as sodium bentonite, attapulgite, kalinite, meta-kaolinite, hectorite, or sepeolite and swellable crosslinked polymers that have the ability to absorb and store aqueous liquids by forming a gel, such as sodium acrylate-based polymers. Otherwise, additional water would be required to account for such loss of water by absorption. For example, the volume of water and any other materials present in the liquid additive may range from about equal to a volume of void space that separates a pre-selected volume of beads to about 30% greater than the volume of void space. The pre-selected volume of lightweight beads may be based on a desired density of a cement composition from which the liquid additive is to be formed. In an embodiment, a mass ratio of the water to the lightweight beads in the liquid additive is less than or equal to about 1:1.

The liquid additive may be prepared at the well site as disclosed herein, for example using a recirculating blender, and optionally stored at the well site following such preparation. Alternatively, the liquid additive comprising the lightweight beads and fluid may be prepared off-site and stored until needed and then transported in a vessel or tank to an on-site location near where a wellbore penetrating a subterranean formation is located. Alternatively, the liquid additive may be prepared off-site and subsequently transported to the on-site location and then stored until needed. Maintaining the lightweight beads in a liquid before it is used helps prevent the beads from forming an agglomeration that probably could not be used in a cement composition. Transporting the lightweight beads in a liquid also avoids various problems associated with transporting the beads in a dry blend with the cement. For example, there is no need to be concerned that a portion of the cement could be lost in the transport, for the amount of cement required to form the slurry can be measured on-site. The cement can be stored on-site in the form of neat cement. As such, any excess cement not used in forming the slurry can be used in subsequent operations. The difficulty and costly procedures required to prevent the migration of the beads in the cement and thus maintain a good distribution of the beads throughout the cement is no longer required.

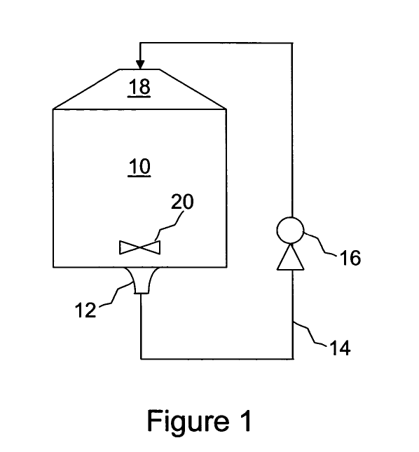

The liquid additive may be prepared, stored and/or transported using a system that is capable of causing the lightweight beads, which naturally float to the top of the liquid additive, to be substantially dispersed throughout the liquid additive. In one embodiment, the system circulates the liquid additive from the bottom of the vessel to near the top of the vessel, thereby forcing the floating lightweight beads toward the bottom of the vessel such that the water and the beads are continuously mixed. As shown in FIG. 1, this system may include a vessel 10 for holding the liquid additive, wherein the vessel 10 has a drain 12 near its base through which the liquid additive can pass out of the vessel 10. It further includes a conduit 14, e.g., a pipe, connected to the drain 12 that extends back to near the top of the vessel 10 for delivering the liquid additive there. A recirculating pump 16 may be disposed in the conduit 14 for conveying the liquid additive from the bottom of the vessel 10 to the top of the vessel 10. A hopper 18 may be connected to the top of the vessel 10 and the conduit 14 for receiving the liquid additive and directing it into the vessel 10. In an embodiment, the liquid additive is prepared, stored and/or transported in a vessel that includes an internal agitation device. For example, a stirrer 20 may be placed in the vessel 10 shown in FIG. 1. In yet another embodiment, the liquid additive is prepared, stored and/or transported in a vessel that is agitated via external means. For example, an external centrifugal pump may be attached to the vessel for circulating the liquid additive in the vessel.

When it is desirable to prepare a cement composition or slurry for use in a wellbore, neat cement previously transported to and, if necessary, stored at the on-site location may be combined with the liquid additive and with additional water and optional other additives to form the cement composition. The resulting cement composition may be pumped down a conduit, e.g., a casing or a drill pipe, run in the wellbore and up into the annulus where it is allowed to set, thereby forming a substantially impermeable cement column that isolates the wellbore. In an embodiment, the concentration of the liquid additive in the cement composition is in a range of from about 0.5 gal/sk to about 3 gal/sk, alternatively, from about 0.5 gal/sk to about 10 gal/sk.

The cement employed in the cement composition may comprise hydraulic cement, which sets and hardens by reaction with water and is typically composed of calcium, aluminum, silicon, oxygen, sulfur, or combinations thereof. Examples of hydraulic cements include but are not limited to Portland cements, pozzolan cements, gypsum cements, high alumina content cements, silica cements, and high alkalinity cements. In an embodiment, the cement is a Portland cement such as a class A, C, G, or H Portland cement or a TXI lightweight oil/well cement commercially available from Texas Industries Inc. of Dallas, Tex. The additional water may comprise fresh water, salt water such as an unsaturated aqueous salt solution or a saturated aqueous salt solution, or combinations thereof. Optional additional additives may be included in the cement compositions as deemed appropriate by those of skill in the art, including but not limited to set retarders, fluid loss control additives, defoamers, dispersing agents, set accelerators, and formation conditioning agents.

In an embodiment, the liquid additive is mixed with the additional water to form a diluted liquid additive, which is subsequently combined with the cement. For example, the liquid additive may be injected into a delivery pump being used to supply the additional water to a cement mixing head for mixing the additional water with the cement. As such, the water used to carry the lightweight beads and this additional water are both available to slurry the cement such that the lightweight beads may be dispersed throughout the cement composition. In an alternative embodiment, the liquid additive is combined with a previously mixed cement slurry as the slurry is being pumped into the wellbore. In both embodiments, the liquid additive may be injected into the suction of the pump. In both embodiments, the liquid additive can be added at a controlled rate to the water or the cement slurry using a continuous metering system (CMS) unit known in the art. The CMS unit can also be employed to control the rate at which the additional water is introduced to the cement as well as the rate at which any other optional additives are introduced to the cement slurry or the water. As such, the CMS unit can be used to achieve an accurate and precise ratio of water to cement and bead concentration in the cement slurry such that the properties of the slurry, e.g., its density, are suitable for the downhole conditions of the wellbore. The concentrations of the components in the cement composition, e.g., the cement and the lightweight beads, can be adjusted to their desired amounts before delivering the composition into the wellbore. Those concentrations thus are not limited to the original design specification of the cement composition and can be varied to account for changes in the downhole conditions of the wellbore that may occur before the composition is actually pumped into the wellbore. In an embodiment, the volume of lightweight beads present in a cement composition having a density of from about 11 to about 14.5 pounds per gallon is less than about 20% by volume of the cement composition, alternatively less than about 10%.

### EXAMPLE

The invention having been generally described, the following example is given as particular embodiments of the invention and to demonstrate the practices and advantages hereof. It is understood that the example are given by way of illustration and is not intended to limit the specification or the claims to follow in any manner.

Eight tests were performed in which 58.8 grams of HGS-10,000 microspheres and 11.7 grams of CFR-3L dispersant were added to different amounts of water to form eight samples in 250 mL graduated cylinders. The eight samples were mixed by placing the dispersant in a beaker and then adding various concentrations of water. Next, the microspheres were added to the resulting mixture by stirring and then folding them into the mixture. The consistency of each sample was observed when it was initially mixed and after waiting for about 6 hours. The amount of water in each sample and the results of these observations are shown below in Table 1. These samples did not stick to the glass when mixed even when they became thick. Sample No. 7 was mixed again after waiting 20 days. It still re-associated very well and appeared to have no change in color when first mixed.

TABLE 1

| | | Amount of | | |
|---|---|---|---|---|
| | Amount | HGS-10000 | Amount of | |
| Sample | of Water, | Microspheres, | CFR-3L dispersant, | |
| No. | g | g | g | Observations |
| 1 | 100 | 58.8 | 11.7 | Slurry was |
| | | | | thin and did |
| | | | | not stick to |
| | | | | the glass |
| 2 | 90 | 58.8 | 11.7 | Slurry was |
| | | | | thin and did |
| | | | | not stick to |
| | | | | the glass |
| 3 | 80 | 58.8 | 11.7 | Slurry was |
| | | | | thin and did |
| | | | | not stick to |
| | | | | the glass |
| 4 | 70 | 58.8 | 11.7 | Slurry was |
| | | | | thin and did |
| | | | | not stick to |
| | | | | the glass |
| 5 | 60 | 58.8 | 11.7 | Slurry was |
| | | | | thiker but |
| | | | | still did not |
| | | | | stick to the |
| | | | | glass |
| 6 | 50 | 58.8 | 11.7 | Slurry was |
| | | | | too thick |
| | | | | but stuck to |
| | | | | the glass |
| | | | | only a little |
| 7 | 55 | 58.8 | 11.7 | Slurry was |
| | | | | thicker but |
| | | | | still did not |
| | | | | stick to the |
| | | | | glass |
| 8 | 58.8 | 58.8 | 11.7 | Slurry was |
| | | | | thicker but |
| | | | | still did not |
| | | | | stick to the |
| | | | | glass. |

While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claims.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural, or other details supplementary to those set forth herein.

1. A method of extending a shelf life of lightweight beads to be used in a cement composition, comprising: combining the lightweight beads with a fluid to inhibit the lightweight beads from forming an agglomeration while they are being stored or transported.

2. The method of claim 1, wherein the shelf life of the lightweight beads is extended to greater than or equal to about 6 months.

3. The method of claim 1, wherein the shelf life of the lightweight beads is extended to greater than or equal to about 1 year.

4. The method of claim 1, wherein the fluid comprises water.

5. The method of claim 1, wherein the lightweight beads comprise borosilicate glass beads.

6. The method of claim 1, wherein said combining the lightweight beads and the fluid forms a liquid additive for the cement composition.

7. The method of claim 4, wherein the liquid additive is substantially absent of a water absorbing material.

8. The method of claim 1, wherein the liquid additive further comprises a dispersant, a cement friction reducer, or combinations thereof.

9. The method of claim 1, wherein the liquid additive is made by a method comprising: (a) selecting a volume of the lightweight beads which are separated by a volume of void space; and (b) combining the lightweight beads with a volume of the fluid ranging from about equal to the volume of the void space to about 30% greater than the volume of the void space.

10. The method of claim 1, wherein a mass ratio of the fluid to the lightweight beads is less than or equal to about 1:1.

11. The method of claim 1, further comprising placing the lightweight beads and the fluid in a vessel and circulating the fluid from a bottom of the vessel to a top of the vessel.

12. The method of claim 11, further comprising agitating the fluid.

13. The method of claim 1, wherein said combining the lightweight beads with the fluid further allows for changes to be made to a concentration of the lightweight beads in the cement composition prior to pumping the cement composition into a wellbore.

14. A method of revitalizing an agglomeration of lightweight beads for use in a cement composition, comprising: adding a fluid to the lightweight beads to reduce a size of the agglomeration.

15. The method of claim 14, wherein the agglomeration originally has a width greater than or equal to about 1 inch.

16. The method of claim 14, wherein said adding the fluid to the lightweight beads causes at least a portion of the beads to separate from the agglomeration into individual beads.

17. The method of claim 16, wherein each individual bead has a width of less than or equal to about 200 microns.

18. The method of claim 16, wherein each individual bead has a width of less than or equal to about 100 microns.

19. The method of claim 16, wherein each individual bead has a width of less than or equal to about 40 microns.

20. The method of claim 14, wherein the fluid comprises water.

21. The method of claim 14, wherein the lightweight beads comprise borosilicate glass beads.

22. The method of claim 14, wherein said combining the lightweight beads and the fluid forms a liquid additive for the cement composition.

23. The method of claim 22, wherein the liquid additive is substantially absent of a water absorbing material.

24. The method of claim 22, wherein the liquid additive further comprises a dispersant, a cement friction reducer, or combinations thereof.

25. The method of claim 14, wherein a mass ratio of the fluid to the lightweight beads is less than or equal to about 1:1.

26. The method of claim 14, further comprising placing the lightweight beads and the fluid in a vessel and circulating the fluid from a bottom of the vessel to a top of the vessel.

27. The method of claim 26, further comprising agitating the fluid.

28. The method of claim 26, further comprising transporting the vessel to a location near a wellbore and combining the fluid and the revitalized lightweight beads with a cement to form a cement composition.

29. The method of claim 28, further comprising changing concentrations of the lightweight beads and the cement in the cement composition prior to pumping the cement composition into the wellbore.
